(19) United States
(12) Patent Application Publication
(10) Pub. No.: US 2021/0367917 A1
(43) Pub. Date: Nov. 25, 2021

(54) DOMAIN NAME BASED VANITY TELEPHONE NUMBER ASSIGNED TO A DOMAIN NAME REGISTRANT

(71) Applicant: Go Daddy Operating Company, LLC, Scottsdale, AZ (US)

(72) Inventor: Tapan Kamdar, San Jose, CA (US)

(21) Appl. No.: 17/116,787

(22) Filed: Dec. 9, 2020

Related U.S. Application Data
(63) Continuation of application No. 15/990,163, filed on May 25, 2018, now abandoned.

(51) Int. Cl. H04L 29/12; G06F 16/22; G06F 16/27; G06F 16/2457

(52) U.S. Cl. CPC H04L 61/3015; H04L 61/1511; G06F 16/24578; G06F 16/27; G06F 16/22

(57) ABSTRACT

A method for a domain name registrar to assign one or more customized vanity phone numbers to a domain name registrant is provided. The domain name registrar may register a domain name to a domain name registrant. The domain name registrar may determine tokens (words or acronyms) from, as non-limiting examples, the domain name, WHOIS data for the domain name, and/or data from a website pointed to by the domain name and/or operated by the domain name registrant. Using the tokens, the domain name registrar may generate a plurality of vanity phone numbers and determine which of those are available. The domain name registrar may present the available vanity phone numbers to the domain name registrant for assignment to the domain name registrant.

### FIELD OF THE INVENTION

The present invention generally relates to the field of generating vanity phone numbers and assigning a selected available vanity phone number to a domain name registrant. The vanity phone numbers may be based, as non-limiting examples, on tokens from a domain name registered to the domain name registrant, WHOIS data for the domain name and/or data from a website of the domain name registrant.

### SUMMARY OF THE INVENTION

The present invention provides methods of generating one or more vanity phone numbers that are likely to be desirable by a domain name registrant, allowing the domain name registrant to select one or more of the available vanity phone numbers and then assigning one or more of the selected available vanity phone numbers to the domain name registrant. Assigning selected available vanity phone numbers to a domain name registrant strengthens the online presence of the domain name registrant by having a vanity phone number related to a domain name and/or a website of the domain name registrant.

The domain name registrar may register a domain name to the domain name registrant. The domain name and contact information for the domain name registrant may be stored in the WHOIS database managed by a domain name registry 170. The domain name may be configured to be used as part of the domain name system (DNS) to allow a computer browser of a website visitor to access a website operated by the domain name registrar.

The domain name registrar may determine one or more tokens that may be used to generate vanity phone numbers using any desired method. As a non-limiting example, the domain name registrar may tokenize a domain name registered to the domain name registrant into one or more tokens. Each token may be a string of sequential characters within the domain name that matches a word or acronym in an electronic dictionary.

As another non-limiting example, the domain name registrar may tokenize WHOIS data for the domain name into one or more tokens. Each token may be a string of sequential characters within the WHOIS data for the domain name that matches a word or acronym in an electronic dictionary.

As another non-limiting example, the domain name registrar may tokenize one or more telephone numbers in the WHOIS data for the domain name into one or more tokens. Each token taken from a telephone number may be a valid 3-digit area code found in the WHOIS data.

As another non-limiting example, the domain name registrar may leverage words from a website pointed to by the domain name and/or a website operated by the domain name registrant. The words from the website may be used as tokens. Each token may be a string of sequential characters within the website pointed to by the domain name or the website operated by the domain name registrant that matches a word or acronym in an electronic dictionary.

As another non-limiting example, the domain name registrar may leverage a category of a website pointed to by the domain name and/or a category of a website operated by the domain name registrant. The category of the website may also be used as a token. Each token may be a string of sequential characters within the category of the website that matches a word or acronym in an electronic dictionary.

As another non-limiting example, the domain name registrar may utilize one or more telephone numbers in the data used to create a website pointed to by the domain name or a website operated by the domain name registrant. The telephone number(s) may also be used as tokens. Each token taken from a telephone number may be a valid 3-digit area code found in the website data or patterns in existing telephone numbers.

It should also be appreciated that the domain name registrar may also search an electronic thesaurus with the tokens to determine one or more tokens that may be added to the tokens already found. It should also be appreciated that the tokens may either be numbers representing a desired area code, replace common words with number (for could be 4) and/or the tokens may be a word or acronym. It should also be appreciated that these methods for determining tokens may be used individually or the methods for determining tokens may be used in any desired combination.

The domain name registrar may generate a plurality of vanity phone numbers so that each vanity phone number comprises at least one of the tokens in the one or more tokens determined as previously described.

The domain name registrar may determine a plurality of available vanity phone numbers by comparing each vanity phone number in the plurality of vanity phone numbers with registered phone numbers in a first database of registered phone numbers. Vanity phone numbers not in the first database of registered phone numbers may be retained as available vanity phone numbers and vanity phone numbers that are in the first database may be discarded as already assigned or registered phone numbers.

The domain name registrar may transmit one or more of the plurality of available vanity phone numbers to a client device operated by the domain name registrant. The domain name registrant may review the available vanity numbers and transmit a decision on whether the domain name registrant desires to own one or more of the available vanity phone numbers to the domain name registrar.

The domain name registrar may receive the selection of an available vanity phone number from the client device operated by the domain name registrant.

The domain name registrar may store at least some of the contact information for the domain name registrant and the selected available vanity phone number in a second database of registered phone numbers that is configured to thereby assign the selected available vanity phone number to the domain name registrant. The selected vanity phone number assigned to the domain name registrant and the second database may be configured so that future telephone calls to the selected vanity phone number are routed to a telephone associated, owned and/or operated by the domain name registrant.

In addition, outgoing phone calls from the telephone associated, owned and/or operated by the domain name registrant could use the vanity phone number as the caller ID for the individual receiving the phone call. The receiving phone client could also support the display of the vanity phone number instead of digits only. E.g. An incoming call from 408-12E-TOYS. p The above features and advantages of the present invention will be better understood from the following detailed description taken in conjunction with the accompanying drawings.

### BRIEF DESCRIPTION OF THE DRAWINGS

FIG. 1 is a block diagram of an example system that permits a domain name registrar to generate and assign a vanity phone number to a domain name registrant, wherein the vanity phone number is based on a domain name registered to the domain name registrant, WHOIS data for the domain name and/or the domain name registrant's website.

FIG. 2 is an illustration of an example key pad that may be found on cell phones and telephones. The key pad has one key for each number (0-9) and some of the numbers (2-9) are associated with three or four letters. As a specific example, the key for the number 2 is typically also associated with the letters A, B and C.

FIG. 3 is an example of the domain name cupcake.com which may be registered to a registrant. Tokens may be based on the domain name, WHOIS data for the domain name and/or from website data of the registrant/domain name.

FIG. 4 is an example of a first token cup and a second token cake, which may be derived from the domain name cupcake.com.

FIG. 5 is an example of WHOIS data for the domain name cupcake.com (this is fictional data for illustrative purposes and does not reflect the actual WHOIS data for the domain name cupcake.com).

FIG. 6 is an example of a small section of code used to generate a website, wherein the website data may include other tokens and/or telephone numbers related to the domain name and/or the domain name registrant.

FIG. 7 is a flowchart of a method for generating and assigning a vanity phone number to a domain name registrant, wherein the vanity phone number is based on a token derived from a domain name registered to the domain name registrant.

FIG. 8 is a flowchart of a method for generating and assigning a vanity phone number to a domain name registrant, wherein the vanity phone number is based on a token derived from WHOIS data for a domain name registered to the domain name registrant.

FIG. 9 is a flowchart of a method for generating and assigning a vanity phone number to a domain name registrant, wherein the vanity phone number is based on a token derived from a telephone number in the WHOIS data for a domain name registered to the domain name registrant.

FIG. 10 is a flowchart of a method for generating and assigning a vanity phone number to a domain name registrant, wherein the vanity phone number is based on a token derived from website data for a domain name registered to the domain name registrant.

FIG. 11 is a flowchart of a method for generating and assigning a vanity phone number to a domain name registrant, wherein the vanity phone number is based on a token derived from a category of a website for a domain name registered to the domain name registrant.

FIG. 12 is a flowchart of a method for generating and assigning a vanity phone number to a domain name registrant, wherein the vanity phone number is based on a token derived from a telephone number in website data for a domain name registered to the domain name registrant.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

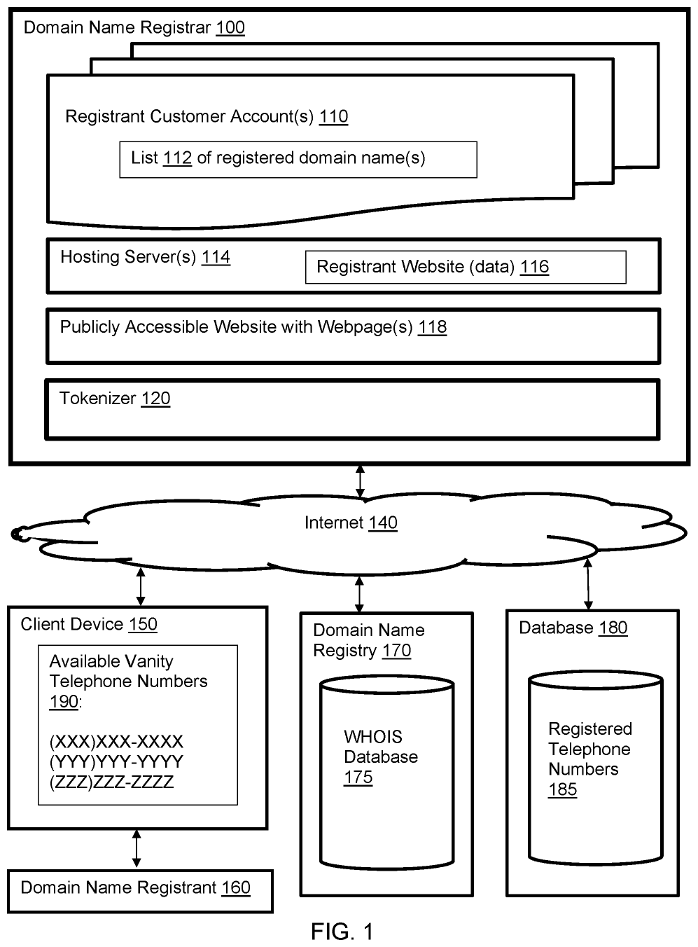

FIG. 1 is a block diagram of a system that may be used to practice the present invention. The domain name registrar 100, domain name registry 170, database 180 of registered telephone numbers 185 and Internet 140 comprise one or more computer networks. These computer networks are defined to be special purpose machines that comprise computer hardware, such as one or more computer hardware servers, and are designed to perform specific functions. Specifically, the computer network for the domain name registrar 100 is a special purpose computer network designed to allow a domain name registrant 160 to register and manage domain names from registrant customer accounts 110 with the domain name registrar 100. The domain name registrant 160 may view and manage a list of domain names 112 registered to the domain name registrant 160.

The computer network for the domain name registry 170 is also a special purpose computer network designed to store all domain names of a particular top-level domain (TLD) that have been registered and store the authoritative information regarding the registered domain names in the WHOIS database 175.

The domain name registrar 100 comprises a publicly accessible website having a plurality of publicly available webpages 118. The website is hosted or operated from one or more hardware servers. The servers may be, as a non-limiting example, one or more Dell PowerEdge(s)® rack server(s) although other types of servers or combinations of one or more servers may also be used.

The computer network for the database 180 is also a special purpose computer network designed to store registered telephone numbers 185 that have already been assigned. The database 180 may also receive telephone numbers and return a response indicating that the telephone number is either already assigned or is available to be assigned.

The arrows in the figures represent computer networks and/or communication paths between computer networks. A computer network is a collection of links and nodes (e.g., multiple computers and/or other client devices connected together) arranged so that information may be passed from one part of the computer network to another over multiple links and through various nodes. Examples of computer networks include the Internet 140, the public switched telephone network, the global Telex network, computer networks (e.g., an intranet, an extranet, a local-area network, or a wide-area network), wired networks, and wireless networks.

The Internet 140 is a worldwide network of computers and computer networks arranged to allow the easy and robust exchange of information between computer users on client devices 150. Billions of people around the world have access to client devices 150 connected to the Internet 140 via Internet Service Providers (ISPs). Content providers place multimedia information (e.g., text, graphics, audio, video, animation, and other forms of data) at specific locations on the Internet 140 referred to as websites. The combination of all the websites and their corresponding webpages on the Internet 140 is generally known as the World Wide Web (WWvV) or simply the Web.

For Internet users and businesses alike, the Internet 140 continues to be increasingly valuable. More people use the Web for everyday tasks, from social networking, shopping, banking, and paying bills to consuming media and entertainment. E-commerce is growing, with businesses delivering more services and content across the Internet 140, communicating and collaborating online, and inventing new ways to connect with each other.

Prevalent on the Internet 140 are multimedia websites, some of which may offer and sell goods and services to individuals and organizations. Websites may consist of a single webpage, but typically consist of multiple interconnected and related webpages. Websites may reside on one or more hardware servers and are typically prepared, maintained, controlled and owned by a single individual or entity. The single individual or entity is usually the domain name registrant 160 of the domain name that points to the website. Menus, links, tabs, etc. may be used by website visitors with a client device 150 and browser to move between different webpages within the website or to move to a different website.

Websites may be created using HyperText Markup Language (HTML) to generate a standard set of tags that define how the webpages for a website are to be displayed. Users of the Internet 140 (website visitors) may access content providers' websites using software known as an Internet browser, such as MICROSOFT INTERNET EXPLORER®, GOOGLE CHROME® or MOZILLA FIREFOX®. After a browser has located a desired webpage (through the use of the DNS or cache memory), the browser may request and receive information from the webpage, typically in the form of an HTML document, and then display the webpage content to the website visitor on the client device 150. The website visitor may send and receive information from the webpage of the website. The website visitor may also view other webpages at the same website or move to an entirely different website using the browser.

Some domain name registrants 160, typically those that are larger and more sophisticated, may provide their own hardware, software, and connections to the Internet 140 to host their own registrant website 116. However, many domain name registrants 160 either do not have the resources available or do not want to create and maintain the infrastructure necessary to host their own registrant websites 116. To assist such domain name registrants 160, hosting companies exist that offer website hosting services. In some cases, a domain name registrar 100 may also offer hosting services so that after a domain name registrant 160 has registered a domain name, the domain name registrant 160 may purchase hosting services from the domain name registrar 100 for the website pointed to by, i.e., associated with, the registered domain name. The hosting providers typically provide the hardware, software, and electronic communication means necessary to connect multiple websites to the Internet 140. A single hosting provider may literally host thousands of websites on one or more hosting servers 114.

Browsers are able to locate specific websites because each website, resource, and computer on the Internet 140 has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The newer IP address standard, often called IP Version 6 (IPv6), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet 140. A browser is able to access a website on the Internet 140 through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization. i.e., a domain name registry 170, for maintaining an authoritative source of information for the registered domain names within a TLD and their corresponding IP addresses.

For certain TLDs (e.g., .biz, .info, .name, and .org) the domain name registry 170 is also the authoritative source for contact information related to the domain name and is referred to as a “thick” registry. For other TLDs (e.g., .com and .net) only the domain name, registrar identification and name server information is stored within the domain name registry 170, and a domain name registrar 100 is the authoritative source for the contact information related to the registered domain name. Such registries are referred to as “thin” registries. Most domain names having a gTLDs are organized through a Shared Registration System (SRS) based on their TLD.

A domain name registrant 160 is hereby defined to be a person or entity that is in the process of registering a domain name or who has already registered the domain name. The domain name registrant 160 may use a client device 150, such as, as non-limiting examples, a cell phone, PDA, tablet, laptop computer, or desktop computer to access a website (such as their own registrant website or a website of a domain name registrar 100) via a computer network, such as the Internet 140. The client device 150 is hereby defined to be a machine that comprises computer hardware and a browser that is able to access a website over the Internet 140.

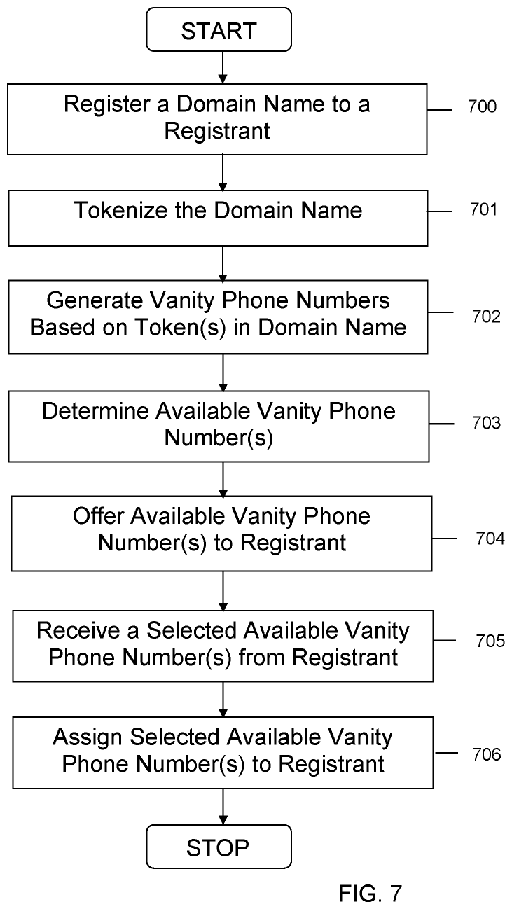

A method of practicing the invention will now be discussed with reference to FIG. 7. The method allows a domain name registrar 100 to assign a selected available vanity phone number to a domain name registrant 160. A domain name registrant 160 that wishes to register a domain name may first determine whether the domain name is available for registration through the use of a webpage supported by a domain name registrar 100. The webpage may be a publicly accessible webpage of a domain name registrar 100 that is available to all Internet visitors, customers and domain name registrants 160.

A domain name registrar 100 is hereby defined to be configured to allow each domain name registrant 160 (customer) to create a registrant customer account 110 so that the domain name registrar 100 comprises a plurality of registrant customer accounts 110 assigned to a plurality of domain name registrants 160. Each domain name registrant 160 may create a registrant customer account 110 with a domain name registrar 100. As the domain name registrar 100 will have a plurality of customers, i.e., domain name registrants 160, the domain name registrar 100 will manage a plurality of registrant customer accounts 110. Internet users, customers and domain name registrants, other than the domain name registrant 160 that owns or registered the registrant customer account 110, are not given access to the registrant customer accounts 110 of other registrants. In other words, the registrant customer accounts 110 are private to all except the domain name registrant 160 that is associated with that specific registrant customer account 110.

The domain name registrar 100 is further defined to register a domain name selected by the domain name registrant 160 to the domain name registrant 160. (Step 700) The domain name and a contact information for the domain name registrant 160 may be stored in the WHOIS database 175 by a domain name registry 170 as part of the domain name registration process. The domain name may also be configured to be used as part of the domain name system (DNS). This allows a computer browser operated by a website visitor to access a website operated by the domain name registrar 100. The domain name registrar may also comprise a tokenizer 120. The tokenizer 120 may be used to find tokens in domain names, WHOIS data and/or website data.

FIG. 7 illustrates an embodiment for the domain name registrar 100 to determine one or more tokens directly from a domain name registered to the domain name registrant 160. The domain name registrar 100 may tokenize the domain name registered to the domain name registrant 160 into one or more tokens. Each token may be a string of sequential characters within the domain name that matches a word or an acronym in an electronic dictionary. Thus, each token is preferably either a word or an acronym. (Step 701)

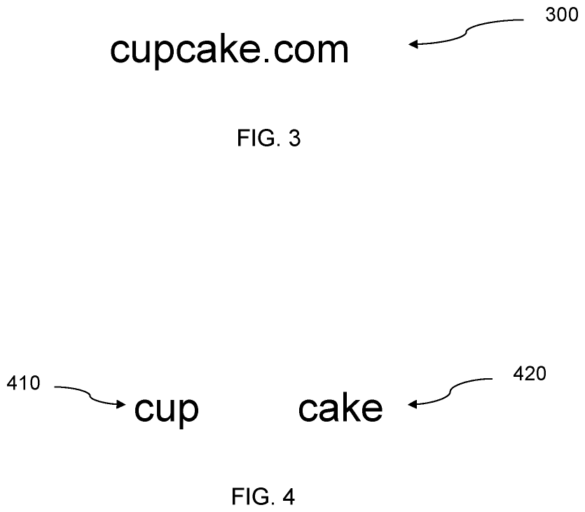

As an example, the domain name cupcake.com is illustrated in FIG. 3. The text of the domain name may be parsed one letter at a time to determine tokens. Thus, the strings of “c,” “cu,” and “cup,” may be parsed and compared to a dictionary which may be used to recognize that “cup” is a word. The, strings of “c,” “ca,” “cak,” and “cake” may also be parsed and compared to the dictionary which may be used to determine that “cake” is also a recognized as a word, while the other character strings are not recognized as words. Thus, in the example illustrated in FIGS. 3 and 4, the domain name registrar 100 may determine that the domain name cupcake.com may best be tokenized to the two tokens of “cup” and “cake” as all of the letters are used to produce two common recognized words.

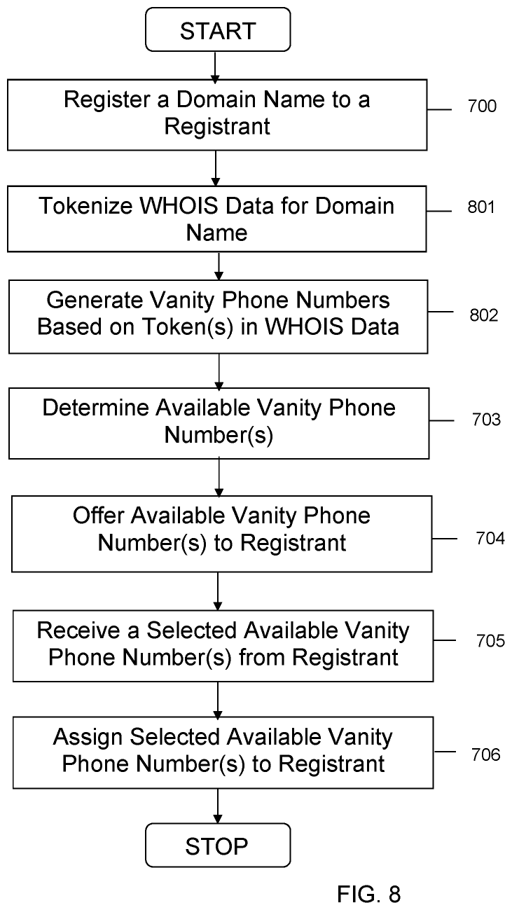

FIG. 8 illustrates an embodiment for the domain name registrar 100 to determine one or more tokens from WHOIS data for the domain name registered to the domain name registrant 160. The domain name registrar 100 may tokenize the WHOIS data for the domain name registered to the domain name registrant 160 into one or more tokens. Each token may be a string of sequential characters within the WHOIS data for the domain name that matches a word or an acronym in an electronic dictionary. Thus, each token from the domain name is preferably either a word or an acronym. (Step 801)

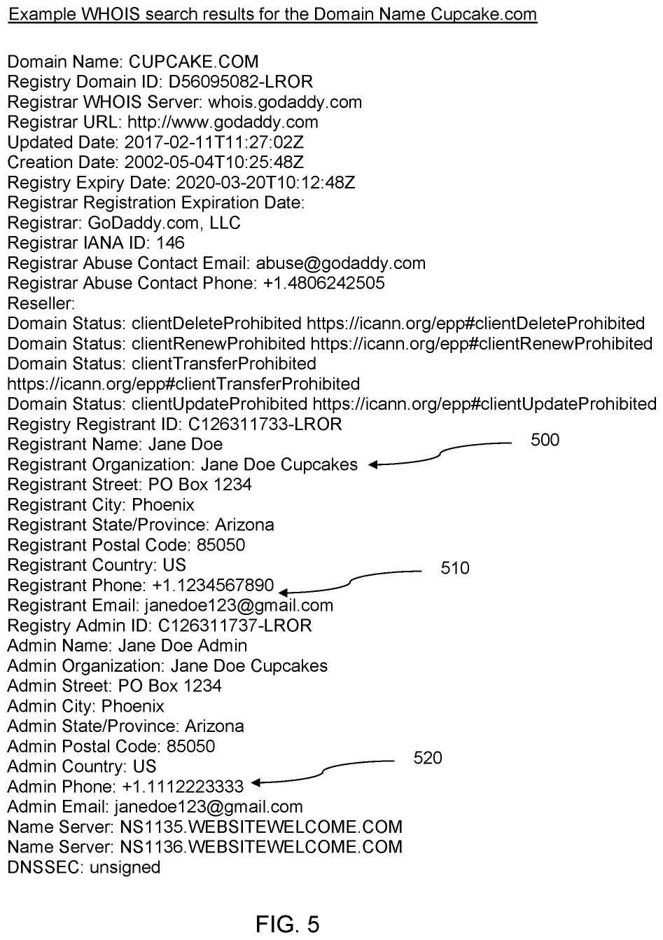

An illustrative (not actual) representative of WHOIS data for the domain name cupcake.com is illustrated in FIG. 5. The text of the WHOIS data for the domain name registered to the domain name registrant 160 may be parsed one character at a time to determine tokens. In other embodiments, particular parts of the WHOIS data may be parsed for tokens. As a possible example, the WHOIS data for the Registrant Organization may be the string of “Jane Doe Cupcakes” 500. This part of the WHOIS data may be parsed into various strings which may be compared to an electronic dictionary. Thus, this process may be used to determine that “Jane,” “Doe,” “cup” and “cake” are all possible tokens in the WHOIS data for the domain name (cupcake.com) registered to the domain name registrant 160.

Using the WHOIS data as well as the user's account registration data, the system may leverage an understanding of the customer's business name, individual's name, address, phone number and email address. These fields may be leveraged to suggest recommendations for area code (based on address and current phone number), and the remaining digits which form the vanity phone number.

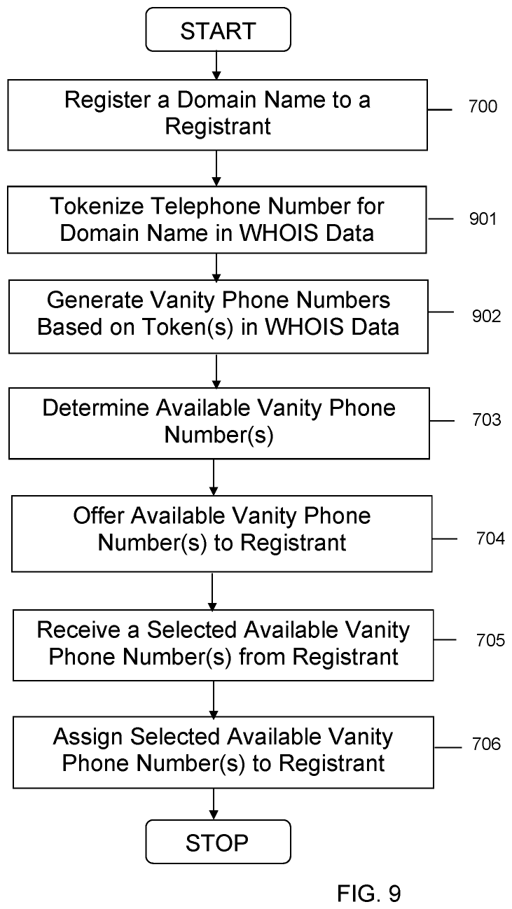

FIG. 9 illustrates an embodiment for the domain name registrar 100 to determine tokens from telephone numbers in WHOIS data for the domain name registered to the domain name registrant 160. The domain name registrar 100 may tokenize telephone numbers in the WHOIS data for the domain name registered to the domain name registrant 160 into one or more tokens. Each token may be a string of sequential numbers within the WHOIS data for a telephone number found in the WHOIS data. In preferred embodiments, the tokens are the area codes for the telephone numbers found in the WHOIS data. (Step 901)

An illustrative (not actual) representative of WHOIS data for the domain name cupcake.com is illustrated in FIG. 5. The text of the WHOIS data for the domain name registered to the domain name registrant 160 may be parsed one character at a time to determine tokens from strings of characters recognized as being in the pattern of a telephone number. In other embodiments, particular parts of the WHOIS data may be parsed for tokens.

As possible examples, the WHOIS data for the Registrant Phone may be the string of “+1.1234567890” 510 and the Admin Phone may be the string of “+1.1112223333” 520. These parts of the WHOIS data may be parsed into various strings to determine desired area codes. Thus, in these examples, the telephone numbers of “+1.1234567890” may be parsed to determine an area code of “123” and the telephone number of “+1.111222333” may be parsed to determine an area code of “111.” This process may be used to determine that “123” and “111” are possible tokens from the telephone numbers in the WHOIS data for the domain name (cupcake.com) registered to the domain name registrant 160. As these are telephone numbers previously assigned to the domain name registrant 160, these area codes are likely to be area codes desired to be used by the domain name registrant 160.

Different area codes from the customer's information could be leveraged to understand an area of service for the business to recommend vanity phone numbers. E.g. 408 and 650 area codes could be leveraged to use “SF”, “Bay Area” as additional tokens to use for recommending vanity phone numbers.

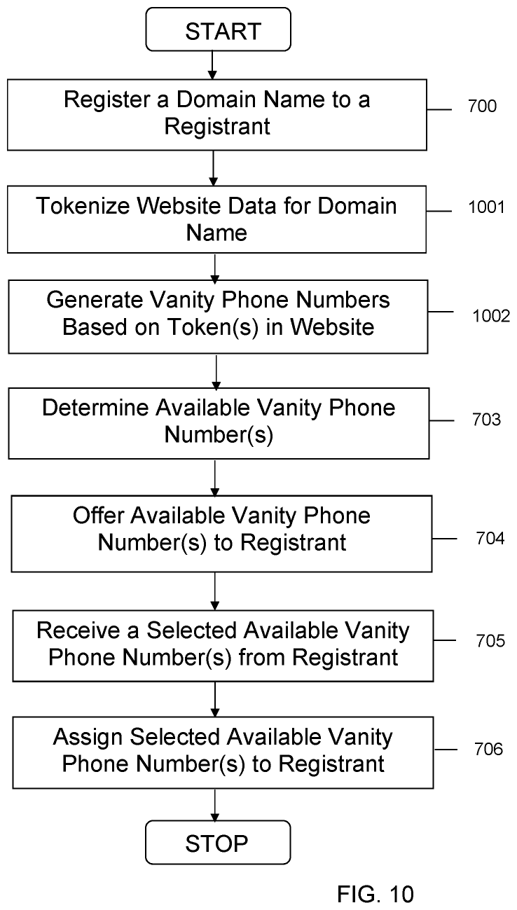

FIG. 10 illustrates an embodiment for the domain name registrar 100 to determine tokens from data in a website 116 for a domain name registered to the domain name registrant 160. The website 116 may be hosted by any hosting service on any hosting servers 114, but is preferably hosted by a hosting service offered by the domain name registrar 100. The domain name registrar 100 may tokenize data (such as the HTML code used to generate the various webpages of the website 116 and/or the tags and the comments in the HTML code) in the website 116 for the domain name registered to the domain name registrant 160 into one or more tokens. Each token may be a string of sequential characters within the data in the data for the website 116 for the domain name that matches a word or an acronym in an electronic dictionary. Thus, each token is preferably either a word or an acronym. (Step 1001)

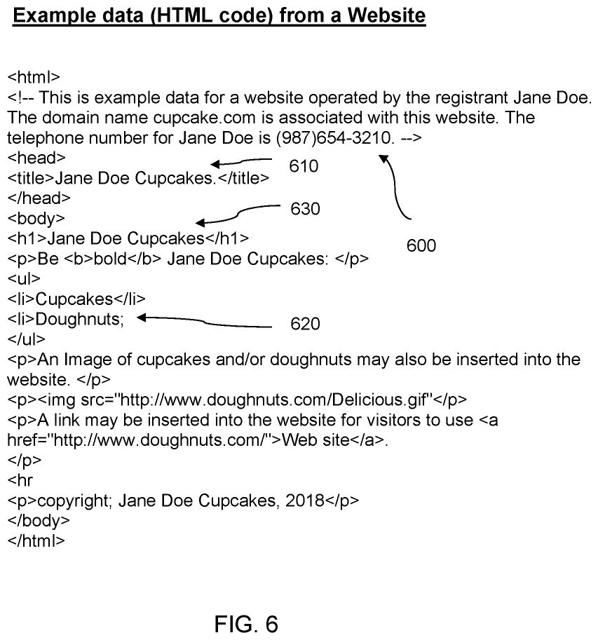

FIG. 6 illustrates a small illustrative (not actual) representative of data from a website 116, in this case a small section of HTML code, for a website 116 pointed to be a domain name registered to the domain name registrant 160 and/or a website 116 operated by the domain name registrant 160. The text of the data from the website 116 may be parsed one character at a time to determine tokens. In other embodiments, particular parts of the data from the website 116 may be parsed for tokens. As possible examples, the title data (Jane Doe Cupcakes) 610, the header data (Jane Doe Cupcakes) 630 and/or emphasized text (Cupcakes and Doughnuts) 620 may be selected for tokenization. These parts of the data from the website 116 may be parsed into various strings which may be compared to an electronic dictionary. Thus, this process may be used to determine that “Jane,” “Doe,” “cup,” “cake,” “dough,” and “nuts” are all possible tokens in the data for the website 116.

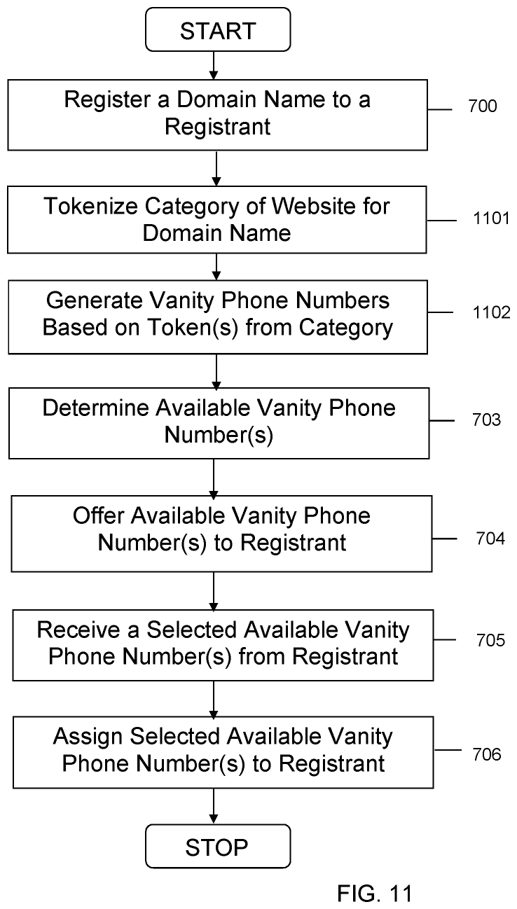

FIG. 11 illustrates an embodiment for the domain name registrar 100 to determine tokens from a category of a website 116 for a domain name registered to the domain name registrant 160. The category for the website 116 may be determined by any desired method. As a non-limiting example, the category of the website 116 may be determined from data from the website 116 and/or from a template selected for the website 116. The domain name registrar 100 may tokenize the determined category of the website 116 for the domain name registered to the domain name registrant 160 into one or more tokens. Each token may be a string of sequential characters within the category for the website 116 that matches a word or an acronym in an electronic dictionary. Thus, each token is preferably either a word or an acronym. (Step 1101)

The text of the category for the website 116 pointed to by the domain name registered to the domain name registrant 160 may be parsed one character at a time to determine tokens. As possible examples, a category of “pool supplies” may be determined from data from the website 116 (not shown) and selected for tokenization. The category of the website 116 may be parsed into various strings which may be compared to an electronic dictionary. Thus, in this example the process may be used to determine that “pool” and “supplies” are possible tokens for the category of the website 116 pointed to by the domain name registered to the domain name registrant 160.

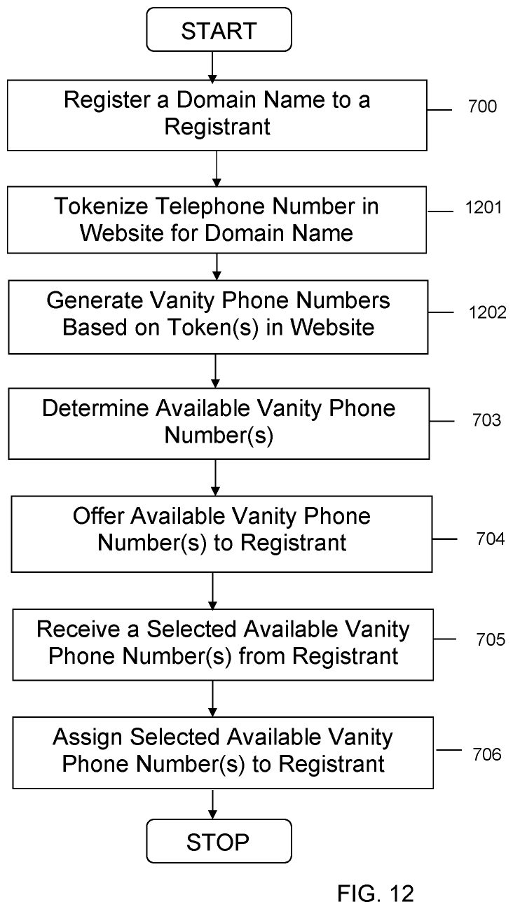

FIG. 12 illustrates an embodiment for the domain name registrar 100 to determine tokens from telephone numbers in data from a website 116. The website 116 may be either the website 116 pointed to by the domain name registered to the domain name registrant 160 and/or a website 116 operated by the domain name registrant 160. The domain name registrar 100 may tokenize telephone numbers in the website 116 data into one or more tokens. Each token may be a string of sequential numbers within a telephone number found in the website 116. In preferred embodiments, the tokens are the area codes for the telephone numbers found in the website 116 data. (Step 1201)

FIG. 6 illustrates a small sample (not actual) of data in a website 116 (the HTML code). The text of the website 116 data may be parsed one character at a time to determine the tokens. In other embodiments, particular parts of the data in the website 116 may be parsed for the tokens. As possible examples, the website 116 data may be parsed looking for numbers in a format normally used to express a telephone number. As an example in the website 116 data illustrated in FIG. 6, the string of “(987)654-3210” may be found. The website 116 data may be parsed into various strings to determine desired area codes. Thus, the telephone number of “(987)654-3210” may be parsed to determine an area code of “987.” Thus, this process may be used to determine that “987” is a possible token from a telephone number in data from a website 116. As this is a telephone number previously assigned to the domain name registrant 160, this area code is likely to be an area code desired by the domain name registrant 160.

Some of the above methods recited the use of an electronic dictionary. While any electronic dictionary may be used, in preferred embodiments, the electronic dictionary may include words and/or acronyms from one or more languages, geographical areas, business terms, technical terms, social media terms, slang and/or terms from current events.

In another embodiment, tokens may be determined based on IP address of the visitors to a website 116 pointed to by a domain name registered to the domain name registrant 160. The domain name registrar 100 may store and then analyze the IP address of the visitors to the website 116. The domain name registrar 100 may determine the most common area code of the website visitors based on the most common IP address of the visitors. The area code or area codes that are the most common may be used as tokens in creating vanity phone numbers. A vanity phone number that uses an area code that is the same as many of the domain name registrar's customers (website visitors) may provide some level of familiarity and trust to the domain name registrar's customers for the website 116 that displays the vanity phone number.

The domain name registrar 100 may generate a plurality of vanity phone numbers for a domain name registrant 160 using one or more of tokens. It should be appreciated that the tokens may either be numbers representing a desired area code and/or the tokens may be a word or an acronym. While the tokens may be determined using any desired method, as non-limiting examples the tokens are found in 1) a domain name registered to a domain name registrant 160 (Step 702); 2) a WHOIS data for the domain name (Step 802); 3) a telephone number in the WHOIS data for the domain name (Step 902); 4) a data from a website 116 pointed to by the domain name (Step 1002); 5) a category of the website 116 pointed to by the domain name (Step 1102); and/or 6) a telephone number in the data from the website 116 pointed to by the domain name (Step 1202). It should also be appreciated that the domain name registrar 100 may also search an electronic thesaurus with the tokens to determine one or more tokens, i.e., synonyms, that may be added to the tokens already found.

The domain name registrar 100 may rank the one or more tokens using any desired method. As a non-limiting example, the domain name registrar 100 may rank the one or more tokens into higher ranked tokens and lower ranked tokens according to how frequently the one or more tokens appear in other domain names registered to the domain name registrant 160. As another non-limiting example, the domain name registrar 100 may rank the tokens into higher ranked tokens and lower ranked tokens according to how frequently the one or more tokens appear in other websites 116 operated by the domain name registrant 160. The more frequently a token is found in other domain names registered to the domain name registrant 160 and/or the more frequently the token is found in other websites 116 of the domain name registrant 160, the higher the ranking of the token. The domain name registrar 100 may then use the highest ranked token or the higher ranked tokens in generating a plurality of vanity phone numbers while not using the lower ranked tokens in generating the plurality of vanity phone numbers.

The domain name registrar 100 may generate a plurality of vanity phone numbers based on the one or more tokens determined using one or more of the previously described methods for finding tokens. Each vanity phone number comprises at least one of the tokens in the one or more tokens. As an example, given 1) the token of “cake” or 2) given the token of area code (480) and the token of “cake,” the domain name registrar 100 may generate the plurality of vanity phone numbers of (480) ***-cake, (480) **c-ake*, (480) *ca-ke**, (480) cak-e***, where the “*” symbol represents a wild card character that may represent any number. It should be appreciated that in the United States each 3-digit area code is followed by a 3-digit prefix. Only some combinations of 3-digit area codes are valid and only some 3-digit prefixes are valid for each area code. Invalid area codes and invalid 3-digit prefixes should be discarded. International phone numbers also follow various rules in format, and, if an international phone number is desired, international phone numbers that do not follow the proper international format may also be discarded.

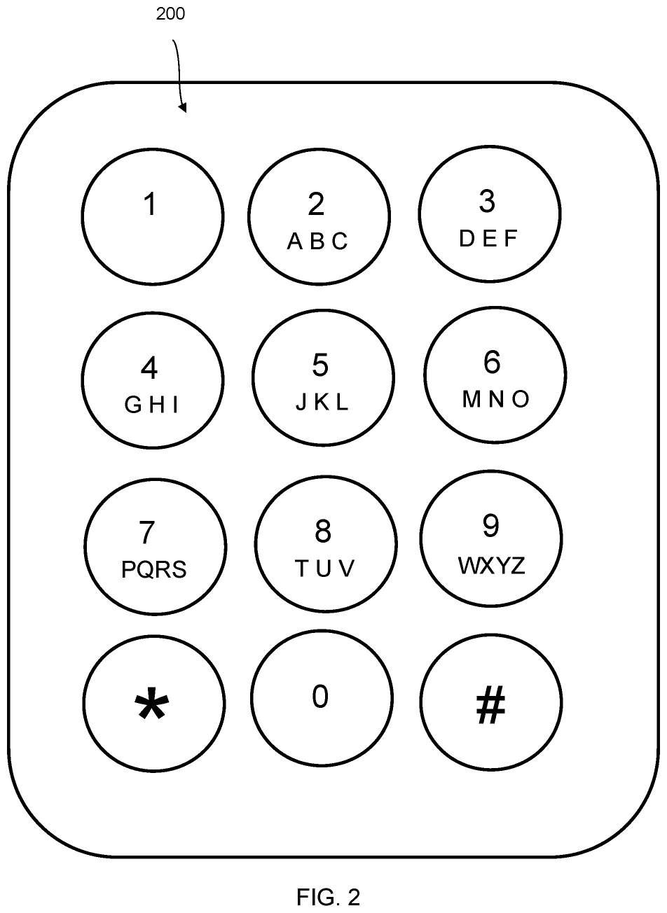

FIG. 2 is an illustration of an example key pad 200 that may be found on cell phones and telephones. The key pad 200 may be used to dial a telephone number from a cell phone or telephone. The key pad 200 has one key for each number (0-9) and some of the numbers (2-9) are associated with three or four letters. As specific examples, the key for the number 2 is associated with the letters A, B and C, the number 3 is associated with the letters D, E and F and the number 5 is associated with the letters J, K and L. Thus, the vanity phone number of (480) ***-cake may be translated to (480) ***-2253. Other vanity phone numbers with one or more tokens may be determined in a similar manner.

The domain name registrar 100 may determine which vanity phone numbers in the plurality of vanity phone numbers generated are available for assignment. Any vanity phone number that includes an invalid area code or an invalid prefix for the area code may be immediately discarded. In other embodiments, the plurality of vanity phone numbers are generated to only include valid area codes with valid 3-digit prefixes. Removing invalid vanity phone numbers greatly improves the process as checking the availability of vanity phone numbers is currently a slow process.

A plurality of available vanity phone numbers 190 may be determined by comparing each vanity phone number in the plurality of vanity phone numbers with registered telephone numbers in a first database 180 of registered telephone numbers. Vanity phone numbers that are available may be placed in a group of available vanity phone numbers 190, while already assigned/registered vanity phone numbers may be discarded. The comparison of vanity phone numbers to already assigned phone numbers may be performed by the domain name registrar 100 or by a third party. If a third party is used, the domain name registrar 100 may either transmit each vanity phone number to the third party with wild cards, such as (480) ***-2253 (and the third party checks the availability of every possible valid permeation) or the domain name registrar 100 may replace each wild card with each possible number before sending the vanity phone number to the third party. (Step 703)

The domain name registrar 100 may rank the plurality of available vanity phone numbers 190 into higher ranked available vanity phone numbers and lower ranked available vanity phone numbers using any desired method. As an example, the domain name registrar 100 may rank the available vanity phone numbers 190 according to how frequently the one or more tokens in the available vanity phone numbers 190 appear in other websites 116 operated by the domain name registrant 160. As another example, the domain name registrar 100 may rank the available vanity phone numbers 190 according to how frequently the one or more tokens in the available vanity phone numbers 190 appear in other domain names registered to the domain name registrant 160.

In addition, ranking may take into account what tokens and patterns have been purchased in the past by similar users to rank those patterns higher as compared to other patterns.

The domain name registrar 100 may transmit one or more of the plurality of available vanity phone numbers 190 to a client device 150 operated by the domain name registrant 160. In preferred embodiments, the domain name registrar 100 transmits the higher ranked available vanity phone numbers and does not transmit the lower ranked available vanity phone numbers to the client device 150. (Step 704)

The domain name registrar 100 may receive a selection of an available vanity phone number 190 from the client device 150 operated by the domain name registrant 160. This is an indication that the domain name registrar 100 desires to purchase the available vanity phone number 190. In some embodiments, the domain name registrant 160 may select a plurality of available vanity phone numbers 190. (Step 705)

The domain name registrar 100 may store at least some of the contact information for the domain name registrant 160 and the selected available vanity phone number 190 in a second database 180 of registered phone numbers to thereby assign/register the selected available vanity phone number to the domain name registrant 160. The second database may be configured such that any person who dials the selected available vanity phone number (which is now no longer available as it is assigned to the domain name registrant 160) on a telephone or cell phone will be directed to a telephone or cell phone of the domain name registrant 160. (Step 706)

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method for a domain name registrar to assign a selected available vanity phone number to a domain name registrant, comprising the steps of:
registering by the domain name registrar a domain name to the domain name registrant, wherein the domain name and a contact information for the domain name registrant are stored in the WHOIS database and the domain name is configured to be used as part of the domain name system (DNS) to allow a computer browser to access a website operated by the domain name registrar;
tokenizing by the domain name registrar the domain name registered to the domain name registrant into one or more tokens, wherein each token is a string of sequential characters within the domain name that matches a word or acronym in an electronic dictionary;
generating by the domain name registrar a plurality of vanity phone numbers, wherein each vanity phone number comprises at least one of the tokens in the one or more tokens;
determining by the domain name registrar a plurality of available vanity phone numbers by comparing each vanity phone number in the plurality of vanity phone numbers with registered phone numbers in a first database of registered phone numbers;
transmitting by the domain name registrar one or more of the plurality of available vanity phone numbers to a client device operated by the domain name registrant;
receiving by the domain name registrar a selection of an available vanity phone number in the one or more of the plurality of available phone numbers from the client device operated by the domain name registrant; and
storing by the domain name registrar at least some of the contact information for the domain name registrant and the selected available vanity phone number in a second database of registered phone numbers to assign the selected available vanity phone number to the domain name registrant.

2. The method of claim 1, further comprising the steps of:
ranking by the domain name registrar the one or more tokens into higher ranked tokens and lower ranked tokens according to how frequently the one or more tokens appear in other websites operated by the domain name registrant; and
wherein the generating the plurality of vanity phone numbers step uses the higher ranked tokens and does not use the lower ranked tokens in generating the plurality of vanity phone numbers.

3. The method of claim 1, further comprising the steps of:
ranking by the domain name registrar the one or more tokens into higher ranked tokens and lower ranked tokens according to how frequently the one or more tokens appear in other domain names registered to the domain name registrant; and
wherein the generating the plurality of vanity phone numbers step uses the higher ranked tokens and does not use the lower ranked tokens in generating the plurality of vanity phone numbers.

4. The method of claim 1, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in other websites operated by the domain name registrant; and
wherein the transmitting the one or more of the plurality of available vanity phone numbers transmits the higher ranked available vanity phone numbers and does not transmit the lower ranked available vanity phone numbers.

5. The method of claim 1, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in other domain names registered to the domain name registrant; and
wherein the transmitting the one or more of the plurality of available vanity phone numbers transmits the higher ranked available vanity phone numbers and does not transmit the lower ranked available vanity phone numbers.

6. The method of claim 1, further comprising the steps of:
ranking by the domain name registrar the one or more tokens into higher ranked tokens and lower ranked tokens according to how frequently the one or more tokens appear in other domain names registered to the domain name registrant or how frequently the one or more tokens appear in other websites operated by the domain name registrant;
wherein the generating the plurality of vanity phone numbers step uses the higher ranked tokens and does not use the lower ranked tokens in generating the plurality of vanity phone numbers;
ranking by the domain name registrar the plurality of available vanity phone number into higher ranked available vanity phone numbers and lower ranked available vanity phone numbers according to how frequently the one or more tokens in the available vanity phone numbers appear in other domain names registered to the domain name registrant or how frequently the one or more tokens appear in other websites operated by the domain name registrant; and
wherein the transmitting the one or more of the plurality of available vanity phone numbers transmits the higher ranked available vanity phone numbers and does not transmit the lower ranked available vanity phone numbers.

7. The method of claim 1, further comprising the steps of:
reading by the domain name registrar one or more synonyms for the one or more tokens from a database; and
wherein one or more of the plurality of vanity phone numbers comprises at least one of the synonyms in the one or more synonyms for the one or more tokens from the database.

8. A method for a domain name registrar to assign a selected available vanity phone number to a domain name registrant, comprising the steps of:
registering by the domain name registrar a domain name to the domain name registrant, wherein the domain name and a contact information for the domain name registrant are stored in the WHOIS database and the domain name is configured to be used as part of the domain name system (DNS) to allow a computer browser to access a website operated by the domain name registrar;
tokenizing by the domain name registrar data in the WHOIS database for the domain name into one or more tokens, wherein each token is a string of sequential characters within the data stored in the WHOIS database for the domain name;
generating by the domain name registrar a plurality of vanity phone numbers, wherein each vanity phone number comprises at least one of the tokens in the one or more tokens;
determining by the domain name registrar a plurality of available vanity phone numbers by comparing each vanity phone number in the plurality of vanity phone numbers with registered phone numbers in a first database of registered phone numbers;
transmitting by the domain name registrar one or more of the plurality of available vanity phone numbers to a client device operated by the domain name registrant;
receiving by the domain name registrar a selection of an available vanity phone number in the one or more of the plurality of available phone numbers from the client device operated by the domain name registrant; and
storing by the domain name registrar at least some of the contact information for the domain name registrant and the selected available vanity phone number in a second database of registered phone numbers to assign the selected available vanity phone number to the domain name registrant.

9. The method of claim 8, further comprising the steps of:
ranking by the domain name registrar the one or more tokens into higher ranked tokens and lower ranked tokens according to how frequently the one or more tokens appear in other websites operated by the domain name registrant; and
wherein the generating the plurality of vanity phone numbers step uses the higher ranked tokens and does not use the lower ranked tokens in generating the plurality of vanity phone numbers.

10. The method of claim 8, further comprising the steps of:
ranking by the domain name registrar the one or more tokens into higher ranked tokens and lower ranked tokens according to how frequently the one or more tokens appear in other domain names registered to the domain name registrant; and
wherein the generating the plurality of vanity phone numbers step uses the higher ranked tokens and does not use the lower ranked tokens in generating the plurality of vanity phone numbers.

11. The method of claim 8, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in other websites operated by the domain name registrant; and
wherein the transmitting the one or more of the plurality of available vanity phone numbers transmits the higher ranked available vanity phone numbers and does not transmit the lower ranked available vanity phone numbers.

12. The method of claim 8, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in other domain names registered to the domain name registrant; and
wherein the transmitting the one or more of the plurality of available vanity phone numbers transmits the higher ranked available vanity phone numbers and does not transmit the lower ranked available vanity phone numbers.

13. The method of claim 8, further comprising the steps of:
ranking by the domain name registrar the one or more tokens into higher ranked tokens and lower ranked tokens according to how frequently the one or more tokens appear in other domain names registered to the domain name registrant or how frequently the one or more tokens appear in other websites operated by the domain name registrant;
wherein the generating the plurality of vanity phone numbers step uses the higher ranked tokens and does not use the lower ranked tokens in generating the plurality of vanity phone numbers;
ranking by the domain name registrar the plurality of available vanity phone number into higher ranked available vanity phone numbers and lower ranked available vanity phone numbers according to how frequently the one or more tokens in the available vanity phone numbers appear in other domain names registered to the domain name registrant or how frequently the one or more tokens appear in other websites operated by the domain name registrant; and
wherein the transmitting the one or more of the plurality of available vanity phone numbers transmits the higher ranked available vanity phone numbers and does not transmit the lower ranked available vanity phone numbers.

14. The method of claim 8, further comprising the steps of:
reading by the domain name registrar one or more synonyms for the one or more tokens from a database; and
wherein one or more of the plurality of vanity phone numbers comprises at least one of the synonyms in the one or more synonyms for the one or more tokens from the database.

15. A method for a domain name registrar to assign a selected available vanity phone number to a domain name registrant, comprising the steps of:
registering by the domain name registrar a domain name to the domain name registrant, wherein the domain name and a contact information for the domain name registrant are stored in the WHOIS database and the domain name is configured to be used as part of the domain name system (DNS) to allow a computer browser to access a website operated by the domain name registrar;
tokenizing by the domain name registrar a telephone number in the WHOIS database for the domain name into one or more tokens, wherein each token is a string of sequential characters within the data stored in the WHOIS database for the domain name that matches a valid area code for telephone numbers;
generating by the domain name registrar a plurality of vanity phone numbers, wherein each vanity phone number comprises at least one of the tokens in the one or more tokens;
determining by the domain name registrar a plurality of available vanity phone numbers by comparing each vanity phone number in the plurality of vanity phone numbers with registered phone numbers in a first database of registered phone numbers;
transmitting by the domain name registrar one or more of the plurality of available vanity phone numbers to a client device operated by the domain name registrant;
receiving by the domain name registrar a selection of an available vanity phone number in the one or more of the plurality of available phone numbers from the client device operated by the domain name registrant; and
storing by the domain name registrar at least some of the contact information for the domain name registrant and the selected available vanity phone number in a second database of registered phone numbers to assign the selected available vanity phone number to the domain name registrant.

16. The method of claim 15, further comprising the steps of:
ranking by the domain name registrar the one or more tokens into higher ranked tokens and lower ranked tokens according to how frequently the one or more tokens appear in other websites operated by the domain name registrant; and
wherein the generating the plurality of vanity phone numbers step uses the higher ranked tokens and does not use the lower ranked tokens in generating the plurality of vanity phone numbers.

17. The method of claim 15, further comprising the steps of:
ranking by the domain name registrar the one or more tokens into higher ranked tokens and lower ranked tokens according to how frequently the one or more tokens appear in the WHOIS database records for the domain name; and
wherein the generating the plurality of vanity phone numbers step uses the higher ranked tokens and does not use the lower ranked tokens in generating the plurality of vanity phone numbers.

18. The method of claim 15, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in other websites operated by the domain name registrant; and
wherein the transmitting the one or more of the plurality of available vanity phone numbers transmits the higher ranked available vanity phone numbers and does not transmit the lower ranked available vanity phone numbers.

19. The method of claim 15, further comprising the steps of:
ranking by the domain name registrar the plurality of available vanity phone number into higher ranked available vanity phone numbers and lower ranked available vanity phone numbers according to how frequently the one or more tokens in the available vanity phone numbers appear in the WHOIS database records for the domain name; and
wherein the transmitting the one or more of the plurality of available vanity phone numbers transmits the higher ranked available vanity phone numbers and does not transmit the lower ranked available vanity phone numbers.

20. The method of claim 15, further comprising the steps of:
ranking by the domain name registrar the one or more tokens into higher ranked tokens and lower ranked tokens according to how frequently the one or more tokens appear in the WHOIS database records for the domain name or how frequently the one or more tokens appear in other websites operated by the domain name registrant;
wherein the generating the plurality of vanity phone numbers step uses the higher ranked tokens and does not use the lower ranked tokens in generating the plurality of vanity phone numbers;
ranking by the domain name registrar the plurality of available vanity phone number into higher ranked available vanity phone numbers and lower ranked available vanity phone numbers according to how frequently the one or more tokens in the available vanity phone numbers appear in the WHOIS database records for the domain name or how frequently the one or more tokens appear in other websites operated by the domain name registrant; and
wherein the transmitting the one or more of the plurality of available vanity phone numbers transmits the higher ranked available vanity phone numbers and does not transmit the lower ranked available vanity phone numbers.
